(19) United States
(12) Patent Application Publication
(10) Pub. No.: US 2024/0372736 A1
(43) Pub. Date: Nov. 7, 2024

(54) EVALUATING A TRUSTWORTHINESS OF PUF SETS

(71) Applicant: Infineon Technologies AG, Neubiberg (DE)

(72) Inventors: Stefan Seidl, Unterhaching (DE); Berndt Gammel, Markt-Schwaben (DE)

(21) Appl. No.: 18/650,742

(22) Filed: Apr. 30, 2024

(30) Foreign Application Priority Data
May 2, 2023 (DE) 102023204033.6

(51) Int. Cl. H04L 9/32; G06F 21/57

(52) U.S. Cl. CPC H04L 9/3278; G06F 21/57

(57) ABSTRACT

A method for evaluating a trustworthiness of sets of a physically unclonable function (PUF) elements, includes: obtaining first information related to a condition of a first set of PUF elements; obtaining second information related to a condition of a second set of PUF elements; and comparing the first information and the second information to determine the trustworthiness of at least one of the sets. The first set includes a first plurality of PUF elements and the second set includes a second plurality of PUF elements. The information related to the condition includes information indicating a respective subset of the set of PUF elements being used or unused when utilizing the respective set of the PUF elements, and/or includes respective error correction information for a bit sequence generated when utilizing the respective set of the PUF.

### TECHNICAL FIELD

The present disclosure relates to a method for evaluating a trustworthiness of sets or instances of a physically unclonable function, PUF, to a test system for executing such a method and to a device comprising a PUF.

### BACKGROUND

Circuitries generating a chip individual bit sequence based on random process variations during production are sometimes called Physically Obfuscated Key (POK) or, in some publications, Physically Unclonable Function (PUF). The output of such a POK or PUF can be generally represented as a sequence of binary values (bits). From this sequence a cryptographic key can be derived.

There is a need to ensure trustworthiness of a PUF.

### SUMMARY

According to an embodiment, a method for evaluating a trustworthiness of sets of a physically unclonable function, PUF, elements, comprises obtaining first information related to a condition of a first set of PUF elements. The method comprises obtaining second information related to a condition of a second set of PUF elements and comparing the first information and the second information to determine the trustworthiness of at least one of the sets. The first set comprises a first multitude of PUF elements and the second set comprises a second multitude of PUF elements. The information related to the condition comprises information indicating a respective subset of the set of PUF elements being used or unused when utilizing the respective set of the PUF elements; and/or comprises respective error correction information for a bit sequence generated when utilizing the respective set of the PUF.

According to an embodiment, a test system is configured for testing devices having a PUF, the test system configured for executing a method described herein.

According to an embodiment, a device comprises a PUF having a multitude of PUF elements. The device comprises a circuitry for testing the PUF elements with respect to a predefined property to determine information that indicates a result of the test. The circuitry is configured for generating a signal indicating the information, wherein the device comprises an interface configured for providing a signal. The information comprises information indicating a respective subset of the set of PUF elements being used or unused when utilizing the respective set of the PUF elements; and/or comprises respective error correction information for a bit sequence generated when utilizing the respective set of the PUF.

### BRIEF DESCRIPTION OF THE DRAWINGS

Some of the aspects described herein are described herein after whilst making reference to the accompanying drawings in which:

FIG. 1a shows a schematic block diagram of a device that may be used in accordance with aspects described herein;

FIG. 1b shows a schematic block diagram of two devices that may be used in accordance with aspects described herein;

FIG. 2 shows a schematic flow chart of a method according to an embodiment;

FIG. 3 shows a schematic block diagram of PUF sets according to an embodiment;

FIG. 4 shows a schematic block diagram of a test system according to an embodiment; and

FIG. 5 shows a schematic block diagram of a device according to an embodiment.

### DETAILED DESCRIPTION

Equal or equivalent elements or elements with equal or equivalent functionality are denoted in the following description by equal or equivalent reference numerals even if occurring in different figures.

In the following description, a plurality of details is set forth to provide a more thorough explanation of aspects of the present disclosure. However, it will be apparent to those skilled in the art that aspects of the present disclosure may be practiced without these specific details. In other sets, well known structures and devices are shown in block diagram form rather than in detail to avoid obscuring aspects of the present disclosure. In addition, features of the different aspects described hereinafter may be combined with each other, unless specifically noted otherwise.

Aspects described herein relate to Physically Unclonable Functions (PUFs) that may also be referred to as a Physically Obfuscated Keys (POKs). That is, PUF and POK are used herein as synonyms.

A PUF may comprise a multitude of PUF elements, wherein a high number of PUF elements may increase a reliability or trustworthiness of the PUF as a bit sequence, secret or key derived therefrom may rely on an increased number of pieces of information. Such a number of PUF elements may be referred to as a set of the PUF or an instance of the PUF. A same configuration of the PUF in different sets of PUF elements, different instances respectively, may lead to different results based on the variations, e.g., in view of a key derived by use of the PUF thereby allowing for the intended individuality or randomness.

Examples of PUF elements in connection with aspects described herein are any elements of a device that are evaluable with respect to a statistical distribution of properties, the properties influenced by a statistical part of a process. Examples are threshold voltages of transistor elements such as memory cells, resistance values of resistor elements or semiconductor elements or the like, a surface roughness of a generated surface or the like. Alternatively or in addition, the entropy of the key may originate from the randomness of process variations with regard to PUF. For example, a race of two or more signals, a threshold voltage ratio of two or more transistors or the like.

Aspects described hereinafter refer, amongst others, to memory cells, i.e., PUF elements that may store at least one bit of information.

Devices implementing a PUF may select some of the PUF elements available in the device for deriving the bit sequence, from which a unique identifier or key can be derived. Alternatively or in addition, a device may store information that indicates, whether a specific PUF element such as a memory cell requires error correction.

When a manufacturing process results in unwanted statistical distributions of the evaluated properties, e.g., due to an attack that modifies the distribution obtained from the manufacturing process or due to errors in the manufacturing process, the bit sequence obtained from evaluating such a corrupted PUF may have less entropy than possible, such that the derived key may be weak. However, it is difficult or impossible to discover such an issue at the PUF itself.

Aspects benefit from the finding that, a comparison between different sets of the PUF, may reveal or detect such an issue. Aspects relate to compare information of a first set of a PUF and a second set of the PUF and possibly more PUFs, e.g., three, at least five, at least ten, at least twenty or more, several hundred PUFs.

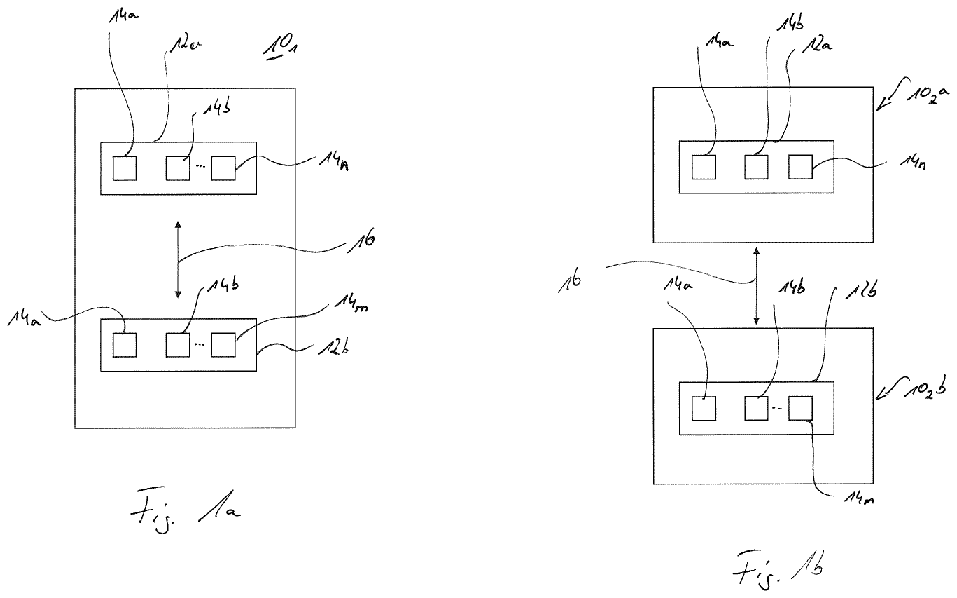

FIG. 1a shows a schematic block diagram of a device 101 that may be used in accordance with aspects described herein. The device 101 may comprise a PUF 12a and a PUF 12b that may each comprise a same or different number or multitude of PUF elements 14a to 14n, 14a to 14m, respectively. The PUF 12a may, thus, be referred to as a set of PUF elements and/or the PUF 12b may be referred to as a set of PUF elements. For example, the PUF may be adapted for using or evaluating a specific number of PUF elements 14 from the available number 14n or 14m of PUF elements such that PUFs 12a and 12b may be considered as different instances of the same PUF, i.e., different sets of PUF elements, even if PUFs 12a and 12b comprise different numbers of PUF elements 14. This does not preclude to have sets 12a and 12b of the PUF with the same number of PUF elements 14. A comparison 16 between information derived from PUF set 12a on the one hand and PUF set 12b on the other hand, may allow to identify issues with regard to a trustworthiness of at least one of the sets 12a and 12b.

FIG. 1b shows a schematic block diagram of devices 102a and 102b that may be used in accordance with aspects. When compared to FIG. 1a, the sets 12a and 12b of the PUF may be located or installed or form a part of different devices 102a and 102b. Comparison 16 between the information of the different sets 12a and 12b may be possible.

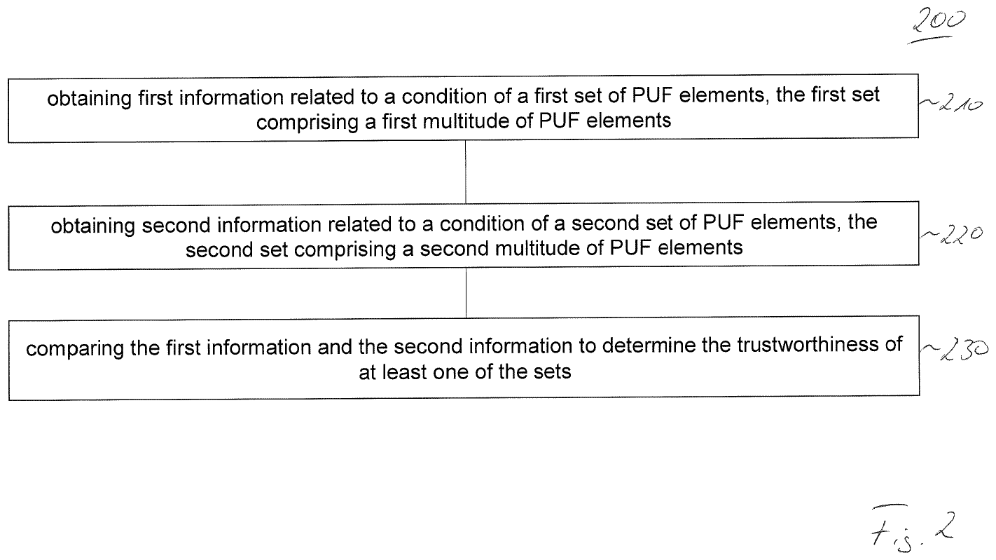

FIG. 2 shows a schematic flow chart of a method 200 according to an embodiment. A step 210 of method 200 comprises obtaining first information related to a condition of a first set of PUF elements, e.g., set 12a. Step 220 comprises obtaining second information related to a condition of a second set PUF elements, e.g., set 12b. Steps 210 and 220 may be performed in any order and/or at least partly at a same time. Step 230 comprises comparing the first information and the second information to determine the trustworthiness of at least one of the sets. Information related to the condition of a first set or a second set may be referred to as condition information. The condition is, however, not necessarily linked to an actual or present operation of the set of the PUF but refers, in general terms, to a condition in connection with the operation. For example, the information or condition information may relate to information whether one or a set of PUF elements is used for the generating a bit sequence and/or whether the PUF element or set of PUF elements is restricted from participating in generating the bit sequence or may indicate a respective subset of the set of PUF elements being used or unused when utilizing the respective set of the PUF elements. Such a condition may be called ‘blacklisted’. Alternatively or in addition, the information related to the condition may comprise respective error correction information for a bit sequence generated when utilizing the respective set of the PUF. For example, the information related to the condition may, as an alternative or in addition, relate to different conditions such as, by way of non-limiting example, information whether the PUF element is a memory cell.

According to an embodiment, the first information 18a may include information related to a condition of a first multitude of sets and the second information 18b may include information related to a condition of a second multitude of sets. That is, a large number of, e.g., at least 10, at least 50, at least 100 or at least 500 sets of PUF elements may be compared. The step 230 of comparing may include a comparison if the examined condition follows a statistical distribution and/or deviates from the statistical distribution of information, e.g., for a single device or for some or all of the devices. For example, the distribution comprises a spatial distribution, e.g., related to a position of PUF elements that comprise a specific condition.

Another finding related to aspects described herein is that the trustworthiness may be evaluated without revealing a secret underlying the PUF, i.e., specific details on how the evaluation of PUF elements 14 is implemented and/or how the secret is obtained in detail. Some of the aspects described herein allow to evaluate or quantify the trustworthiness by using information that prevents revealing secret information.

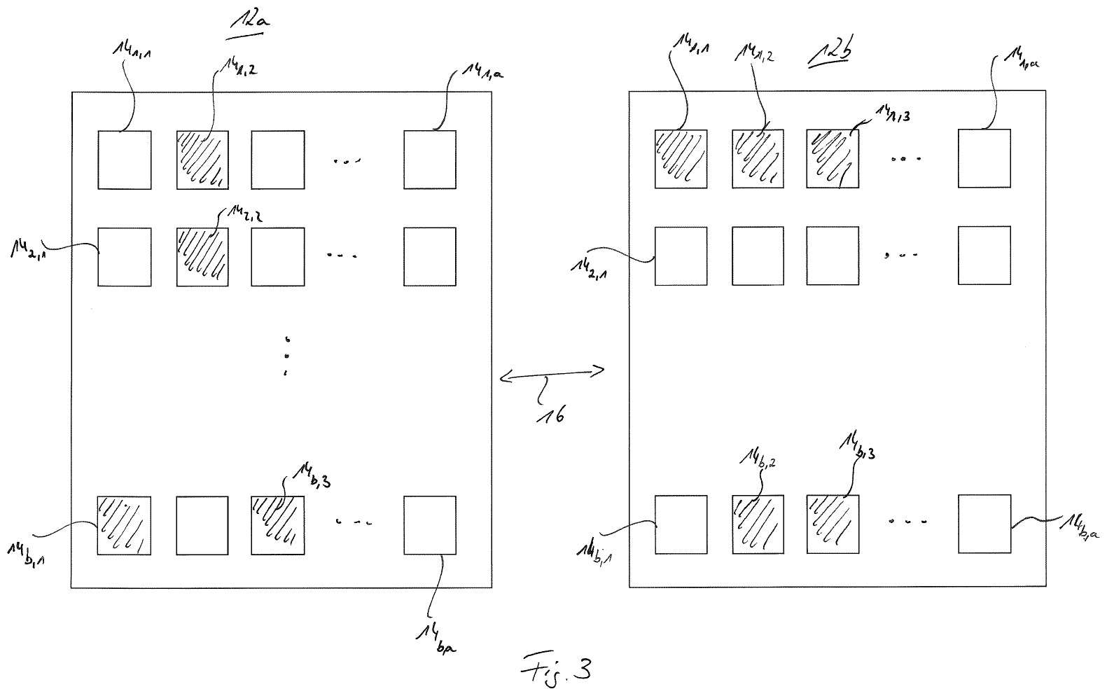

FIG. 3 shows a schematic block diagram of PUF sets 12a and 12b. For example, sets 12a and 12b may be considered as copies. In the given example, PUF elements 14_{1,1} to 14_{b,a} may be arranged or located in both sets 12a and 12b whilst this does not preclude a different number of PUF elements and/or a different layout in at least one of the PUF sets 12a and 12b.

Some aspects described herein are based on the finding that a device comprising or accessing set 12a and/or 12b may have stored therein information on the condition of the PUF and/or may evaluate the PUF elements 14_{1,1} to 14_{b,a} to determine such information on the condition of the PUF. For example, such information may comprise information indicating a subset of PUF elements being used or unused for utilizing the respective set 12a or 12b of the PUF. For example, the device may have stored information or may determine a subset of PUF elements 14 that is used for the PUF and/or a subset that is excluded from such a use. Reasons for excluding or blacklisting PUF elements may be a determined instability of the PUF elements or a fault of the PUF element. Such errors or faults or reasons for blacklisting PUF elements may follow a statistical distribution. As indicated in FIG. 3, in different sets 12a and 12b, different PUF elements 14_{1,2}, 14_{2,2}, 14_{b,1}, and 14_{b,3} in 12a and 14_{1,1}, 14_{1,2}, 14_{1,3}, 14_{b,2} and 14_{b,3} of 12b may form example subsets of blacklisted PUF elements 14 of sets 12a and 12b. The number of blacklisted PUF elements may be same or equal in PUF sets 12a and 12b. Whilst a same number of used bits may be obtained, for example, when selecting a specific number of useful, most useful, or at least unblacklisted PUF elements, a different number may be obtained, for example, when blacklisting erroneous or error prone or otherwise unsuitable PUF elements.

With an assumption that there is a specific kind of statistical distribution within the blacklisted PUF elements, the comparison 16, e.g., performed in part 230, may indicate, that such specific kind of statistical distribution is missing, and that the manufacturing process and/or the template for the PUF is possibly erroneous. This may result in a reduced or eliminated trustworthiness of the PUF.

According to an embodiment, that may be implemented in addition or as an alternative to considering used and/or unused PUF elements, the information may comprise error correction information for a bit sequence, the information being generated when utilizing the respective set of the PUF.

In a similar way as when compared to determine whether to use a PUF element or not, information indicating whether specific PUF elements require error correction and a comparison of such information between different PUF sets may reveal issues of said PUFs.

When referring again to FIG. 3, when a user determines that a comparable number (relating, e.g., to a statistical distribution of the amount of PUF elements) and/or comparable regions (relating, e.g., to a statistical distribution of a location and/or a spatial correlation) of PUF elements are blacklisted, or when he determines that a same number or a same region of PUF elements requires error correction, this may indicate that such PUF elements have been manipulated by the process or by an attacker to limit a range of selection of used PUF elements, thereby reducing the entropy of a derived secret.

According to an embodiment, comparing the first information and the second information may comprise an evaluation whether a first distribution of the multitude of PUF elements 14 within the set 12a and a second distribution of the multitude of PUF elements 14 within the second set 12b deviate according to a statistical distribution and/or are within the statistical distribution. To have two or even a higher number of PUF sets that fail to follow the correct statistical distribution may indicate that the sets of the PUF are not trustworthy. That is, aspects may relate to evaluate a property of a distribution of PUF elements or bits of a subset, e.g., of blacklisted bits and/or helper data. Aspects relate to compare or evaluate said property through a number of at least two sets of the PUF, i.e., to compare the distribution between the sets rather than within a single set. According to one example, an evaluation may compare or determine whether a respective subset is pairwise equal or similar between different sets of the PUF.

For example, the respective first distribution and second distribution may comprise a spatial distribution and/or a number of bits having a predefined property. The spatial distribution shows a location or area, e.g., within a field of memory elements, wherein the predefined property indicates blacklisted memory cells, the reason for blacklisting and/or whether the PUF element requires error correction.

According to an embodiment, method 200 may be performed such that comparing 230 may comprise an evaluation whether a first variation of the condition correlates with a second variation of the condition. For example, when expecting the property to be statistically distributed, a correlation being found between two or more PUF sets may indicate a dependency of PUF elements being used for implementing the PUF and, thus, a weakness of the PUF, which leads to a reduction of the information entropy of the PUF output and the key derived from it. According to an embodiment, the method may be performed such that to determine the trustworthiness of the sets of the PUF a multitude of sets, e.g., more than 1, more than 50, more than 100 or even more than 500 sets are compared whether deviations in the respective property or information related to the condition of the set follows a statistical distribution and/or deviates from the statistical distribution such as a Gaussian distribution or a different distribution relating to randomness. That is, for the multitude of set it may be evaluated whether they deviate as expected or if there are deviations from said expectation, the deviations possibly indicating an issue regarding the trustworthiness.

According to an embodiment, the trustworthiness may relate to a correlation between information processed in the first set 12a and information processed in the second set 12b, the correlation resulting in a degradation of entropy.

According to an embodiment, a multitude of sets to the PUF are compared, e.g., performing part 230, to determine if the trustworthiness is compromised by an attacker, an alteration or modification of a manufacturing process of the PUF.

A PUF e.g., a POK but not limited hereto, may be used to derive a key for cryptographic proposals. Cryptographic keys should always be uniformly distributed and be unique, i.e., statistically independent from chip to chip, i.e., from set to set of the PUF. Statistical independence ensures that the knowledge of the keys from one or more PUF sets does not help an attacker to predict a key derived from another set. Although the design of a PUF is intended to achieve a high randomness, in two example scenarios the randomness could be reduced or destroyed.

For example, a manipulation of exposure masks in a production facility, e.g., a mask house, could be used to program a fixed bit sequence or at least a fixed part of the bit sequence, into the device such that the key is known, i.e., the key has zero entropy, or that is can be guessed with reduced effort due to a key entropy reduction. Such a scenario may be referred to as hardware Trojan insertion.

As an alternative or in addition, an unexpected and maybe undetected process drift may lead to at least partially fixed bit values and hence, a reduced entropy of the key. Such an entropy reduction would also reduce the security of the key.

In order to keep a PUF stable over different temperatures, voltages, and/or other environmental parameters as well as aging, a device may store helper data that is generated for preselection of stable bits and/or error correction. Such helper data may not be a secret. A key extraction with helper data algorithm may be constructed such that the knowledge of the helper data does not enable an attacker to retrieve the key. Aspects have identified that an analysis of this data can detect the issues above. The benefits are even increased when repeating the comparison, e.g., in a continuous way.

When compared to comparing keys or bit sequences determined as the secret or use of the PUF set, such a concept does not require to output the bit sequence and, therefore, to avoid such a security risk.

According to an embodiment, method 200 may be based or may comprise a monitoring and statistical analysis of bit preselections. For PUF design, a preselection of bits may be performed to achieve a lower error rate of the bit stream entering the key generation. One possible process is to repeat the bit generation for a number of times and only bits that show the number of times the identical values are considered as stable. Unstable bits may be blacklisted. Information indicating a subsequent of PUF elements that is used for utilizing the PUF may comprise stable bits. To the contrary, information indicating bits that are unused for utilizing the PUF may be considered as blacklisted PUF elements. For example, one of the respective information may allow a conclusion to the other such that identifying one of the subsets may provide for knowledge about both of them.

Another example process is to bias PUF elements, e.g., respective bits towards a specific value such as 0 or 1. This can, for example, be achieved with dedicated circuits, which detune the PUF elements with respect to some electrical parameters. If a bit shows one or both values, e.g., 0 or 1, in the unbiased state and still shows the same value, i.e., 0 or 1, when it is biased towards the other value 1, 0 respectively, it may be considered as stable. Otherwise, it may get blacklisted. These processes can be combined and/or other concepts may be applied according to aspects that result in information indicating a subset being used for utilizing the set and/or information indicating a subset that is unused for utilizing the PUF.

For example, information indicating PUF elements being excluded from the key generation and, thus, do not form a part of the chip secret key may be indicated as public information.

For example, as the individual values of the PUF depend, as far as possible or only, on the random process variations, the number and position of blacklisted cells may be expected to be random, too. However, if a manipulation of the fabrication process is performed in order to imprint stable bit values onto the chips or PUF sets, the statistic distribution of the blacklisted PUF elements is likely to be affected, too.

Hence, the statistical analysis of blacklisted bits may allow to monitor the fabrication process for unintended drifts, which unintentionally could reduce the key entropy.

Such aspects may be performed whilst benefiting from not revealing information on the key, by allowing a continuous monitoring of the fabrication process, or a testing that may cover a high number or even all of the sets of the PUF/chips, and not only a selected batch and/or that it is not requested to discard chips for the test (yield).

As an alternative or in addition, the statistical analysis of blacklisted bits may provide a strong protection against Trojan insertion as fixing a significant number of bits to known values, e.g., to reduce the efforts to guessing the key, would strongly effect the statistical distributions.

According to an embodiment, based on a PUF element property, the first information may comprise information indicating PUF elements of the first set 12a being excluded from deriving a first secret, i.e., blacklisted bits which may also be referred to as preselection information. The second information may similarly comprise information indicating PUF elements of the second set 12b excluded from deriving a secret PUF set 12b, i.e., preselection information of PUF set 12b. For example, a PUF element being unused includes that the PUF element is excluded from being part of a secret. The comparing 230 may comprise a comparison of a spatial distribution and/or a number of excluded PUF elements. Comparing 230 may be based on a PUF element property that comprises a comparison of a spatial distribution and/or a number of excluded PUF elements.

As an exemplarily but non-limiting example only, it may be considered a scenario in which an attacker fixes all bit values of the PUF. This imprinting may be strong enough to get stable cells. Hence, the number of blacklisted cells may drop to 0 in a case where the blacklisting is based on identifying unstable bits. Even if the attacker uses a very weak imprinting, the number of blacklisted cells can significantly decrease, while the cells become stable enough such hat the attacker can guess the key with high likelyhood. If the attacker would only imprint values in some bits, this might reduce the number of blacklisted cells only slightly, but would still show up in the positions of the blacklisted cells. According to aspects, the information related to the condition of the second set may consider a position, location, or association of the PUF element. Comparing 230 may comprise to perform a statistical analysis, the statistical analysis considering one or more of a number of PUF elements having a specific property and/or a location of PUF elements having a specific property or the like.

The example given above with regard to a possible attack is also valid for the risk of entropy loss due to a manufacturing process drift.

Alternatively or in addition, compared information may comprise helper information related to a first error correction for a first bit sequence derived from set 12a and wherein the other information comprises second helper information related to second error correction for a second bit sequence derived from the second set 12b. Comparing 230 may thus be based on a PUF element property and may comprise a comparison of a distribution of bits to be corrected. For example, the first information 18a may include helper information related to error correction; and the comparing may be based on a distribution of bits to be corrected.

In addition or as an alternative to considering the black lists, error correction may be applied to PUF elements. According to one example, such error correction may be applied to the selected, remaining or not blacklisted bits. Such error correction may require redundancy. For example, such redundancy information may be contained as parity check bits of some error correction codes. Like the preselection information that identifies used and/or unused PUF elements, the helper data may be public, too.

The helper data of different chips may be compared, according to aspects. Such helper data may be expected to follow some statistical distribution. That is, also the statistical distribution of helper data can be monitoring and/or evaluated. With regard to the helper data, i.e., information that indicates error correction information for a bit sequence, similar advantages may be obtained when compared to using information about used/unused PUF elements. Deviations in the distribution of the helper data may reflect the deviations, e.g., due to process drifts or maliciously inserted Trojans, of the selected bits for the key. Although helper data is not necessarily perfectly random, it still has some structure because of the underlying code or implementation, such that it may provide sufficient information for comparing different PUF sets with regard to the trustworthiness of the PUF. Besides determining issues with the trustworthiness in case of an attack or process variations, other defects may be determined such as layout asymmetries, doping variations in semiconductor materials or the like.

According to an embodiment, a method based on method 200 is implemented wherein the first set 12a is used to generate first information representing a first secret, e.g., the bit sequence or the key derived therefrom, wherein the second set is used to generate second information representing a second secret, e.g., a respective comparable bit sequence or key. The trustworthiness may be determined without revealing the first secret and the second secret to one of parts 210, 220 and/or 230.

According to an embodiment, at least one of the sets 12a and 12b may be rejected based on a correction between the first information and the second information exceeding a correlation threshold value. Such a method may benefit from an increased number of PUF sets to be compared. For example, several hundred, several thousand, or more sets of the PUF may be compared. The information that is used for the comparison 230, e.g., the preselection information and/or the helper data, may be determined during or after production of the PUF sets, e.g., using a test system for testing devices having such a PUF. An embodied method may be performed in connection with a manufacturing process for manufacturing sets of the PUF, e.g., sets 12a and 12b. A determined failure of trustworthiness of one or more sets of the PUF may lead at least to one of a pausing of the manufacturing process or a modification of the manufacturing process, e.g., to correct for the process drifts.

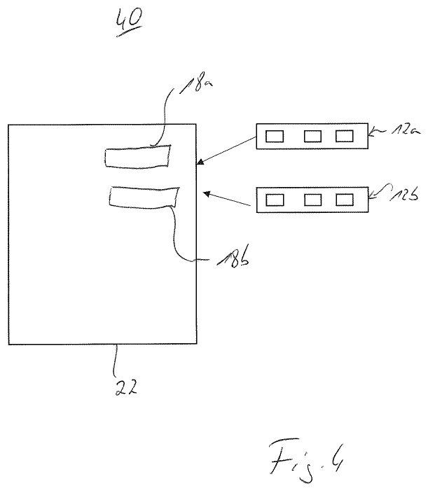

FIG. 4 shows a schematic block diagram of a test system 40 according to an embodiment that is configured for a testing device having sets 12a and 12b of the PUF. Test system 40 may be implemented to execute method 200. From set 12a, information 18a may be obtained that is related to a condition of set 12a. Information 18a may be derived by test system 40, e.g., a test station 22 that is adapted to readout PUF elements, and/or may be determined by a device comprising the PUF set 12a and be transmitted to the test station 22.

Accordingly, information 18b related to a condition of PUF set 12b may be determined at test station 22 and/or at a device comprising set 12b. For example, a device that is configured for determining the information 18b itself may provide such information using an interface that is configured for providing a respective signal.

Collecting and comparing information 18 at the test station 22 may allow to detect slow drifts and/or rapid shifts in information 18 and may allow for an online monitoring of the manufacturing process.

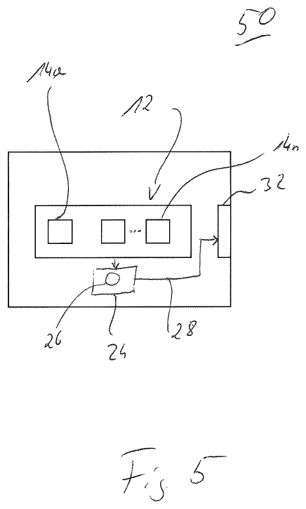

FIG. 5 shows a schematic block diagram of a device 50 according to an embodiment that has a PUF 12 with a multitude of PUF elements 14 as described, for example, in connection with FIG. 1a and/or FIG. 1b. Device 50 may be, for example, a chip card, a battery-powered device to generate a key or other type of PUF carrying device.

Device 50 may comprise a circuitry 24 that is adapted for testing the PUF elements 14a to 14n with respect to a predefined property, e.g., whether they are preselected or restricted/blacklisted and/or whether they require error correction and/or other physical properties, to determine information 26 that indicates a result of the test. The circuitry 24 may be configured for generating a signal 28 indicating the information 26 and may comprise an interface 32 configured for providing the signal 28. The information 26 may comprise information indicating a respective subset of the set of PUF elements being used or unused when utilizing the respective set of the PUF elements; and/or may comprise respective error correction information for a bit sequence generated when utilizing the respective set of the PUF.

Information 26 may form at least a part of information 18 to provide, for example, test station 22 with the information 18 or to allow determination of information 18 at the test station 22.

The circuitry 24 may be configured for determining a secret based on the PUF 12. The device 50 may be configured for providing the signal 28 without revealing the secret.

Aspects according to the present disclosure are described hereinafter in more detail.

According to a first embodiment, a method for evaluating a trustworthiness of sets of physically unclonable function, PUF, elements, the method comprises:
obtaining first information related to a condition of a first set of PUF elements; and
obtaining second information related to a condition of a second set of PUF elements; and
comparing the first information and the second information to determine the trustworthiness of at least one of the sets;
wherein the first set comprises a first multitude of PUF elements and wherein the second set comprises a second multitude of PUF elements;
whereby the information related to the condition comprises information indicating a respective subset of the set of PUF elements being used or unused when utilizing the respective set of the PUF elements; and/or
the information related to the condition comprises respective error correction information for a bit sequence generated when utilizing the respective set of the PUF.

According to a second embodiment that makes reference to embodiment 1, the first information includes information related to a condition of a first multitude of sets and the second information includes information related to a condition of a second multitude of sets.

According to a third embodiment that makes reference to embodiment 1 or 2, the step of comparing includes a comparison if the condition follows a statistical distribution and/or deviates from the statistical distribution of information.

According to a fourth embodiment that makes reference to embodiment 3, the distribution comprises a spatial distribution.

According to a fifth embodiment that makes reference to any one of the previous aspects the method is performed such that comparing the first information and the second information comprises an evaluation whether a first variation of the condition correlates with a second variation of the condition.

According to a sixth embodiment that makes reference to any one of the previous aspects, a multitude of sets of the PUF are compared to determine the trustworthiness with regard to an aging, alteration or modification of a manufacturing process carried out for manufacturing the sets of the PUF.

According to an seventh embodiment that makes reference to any one of the previous aspects, a PUF element being unused includes that the PUF element is excluded from being part of a secret; and wherein the comparing comprises a comparison of a spatial distribution and/or a number of excluded PUF elements.

According to a eighth embodiment that makes reference any one of the previous aspects,
the first information includes helper information related to error correction; and
wherein the comparing is based on a distribution of bits to be corrected.

According to a ninth embodiment that makes reference to any one of the previous aspects, the first set is used to generate first information representing a first secret, wherein the second set is used to generate second information representing a second secret,
such that the trustworthiness is determined without revealing the first secret and the second secret.

According to an tenth embodiment that makes reference to any one of the previous aspects, the first set and/or the second set is rejected based on a correlation between the first information and the second information exceeding a correlation threshold value.

According to a eleventh embodiment that makes reference to any one of the previous aspects, method is performed in connection with a manufacturing process for manufacturing sets of the PUF, wherein a determined untrustworthiness of sets of the PUF leads to at least one of a pausing or modification of the manufacturing process.

According to a twelfth embodiment a computer readable digital storage medium has stored thereon a computer program having a program code for performing, when running on a computer, a method according to one any one of the previous aspects.

According to a thirteenth embodiment a test system (40) is configured for testing devices having a PUF, the test system (40) configured for executing a method according to one of aspects 1 to 11.

According to a fourteenth embodiment a device comprises:
a PUF having a multitude of PUF elements (14a-14n);
a circuitry for testing the PUF elements with respect to a predefined property to determine information that indicates a result of the test; wherein the circuitry is configured for generating a signal indicating the information;
whereby the information comprises information indicating a respective subset of the set of PUF elements being used or unused when utilizing the respective set of the PUF elements; and/or
the information comprises respective error correction information for a bit sequence generated when utilizing the respective set of the PUF;
the device comprises an interface configured for providing the signal.

According to a fifteenth embodiment that makes reference to embodiment 14, the circuitry is configured for determining a secret based on the PUF; wherein the device is configured for providing the signal without revealing the secret.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, aspects of the disclosure can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some aspects according to the disclosure comprise a data carrier having electronically readable control signals, which are capable of cooperating with a programmable computer system, such that one of the methods described herein is performed.

Generally, aspects of the present disclosure can be implemented as a computer program product with a program code, the program code being operative for performing one of the methods when the computer program product runs on a computer. The program code may for example be stored on a machine-readable carrier.

Other aspects comprise the computer program for performing one of the methods described herein, stored on a machine-readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some aspects, a programmable logic device (for example a field programmable gate array) may be used to perform some or all of the functionalities of the methods described herein. In some aspects, a field programmable gate array may cooperate with a microprocessor in order to perform one of the methods described herein. Generally, the methods are preferably performed by any hardware apparatus.

The aspects described above are merely illustrative for the principles of the present disclosure. It is understood that modifications and variations of the arrangements and the details described herein will be apparent to others skilled in the art. It is the intent, therefore, to be limited only by the scope of the impending patent claims and not by the specific details presented by way of description and explanation of the aspects herein.

1. A method for evaluating a trustworthiness of sets of physically unclonable function (PUF) elements, the method comprising:
obtaining first information related to a condition of a first set of PUF elements, wherein the first set comprises a first plurality of PUF elements; and
obtaining second information related to a condition of a second set of PUF elements, wherein the second set comprises a second plurality of PUF elements; and
comparing the first information and the second information to determine the trustworthiness of at least one of the sets,
wherein the information related to the condition comprises information indicating a respective subset of the set of PUF elements being used or unused when utilizing the respective set of the PUF elements, and/or
the information related to the condition comprises respective error correction information for a bit sequence generated when utilizing the respective set of the PUF.

2. The method of claim 1, wherein the first information includes information related to a condition of a first plurality of sets and the second information includes information related to a condition of a second plurality of sets.

3. The method of claim 1, wherein the step of comparing includes a comparison if the condition follows a statistical distribution and/or deviates from the statistical distribution of information.

4. The method of claim 3, wherein the distribution comprises a spatial distribution.

5. The method of claim 1, wherein the method is performed such that comparing the first information and the second information comprises an evaluation whether a first variation of the condition correlates with a second variation of the condition.

6. The method of claim 1, wherein a plurality of sets of the PUF are compared to determine the trustworthiness with regard to an aging, alteration, or modification of a manufacturing process carried out to manufacture the sets of the PUF.

7. The method of claim 1, wherein a PUF element being unused includes that the PUF element is excluded from being part of a secret, and wherein the comparing comprises a comparison of a spatial distribution and/or a number of excluded PUF elements.

8. The method of claim 1, wherein the first information includes helper information related to error correction; and
wherein the comparing is based on a distribution of bits to be corrected.

9. The method of claim 1, wherein the first set is used to generate first information representing a first secret, and the second set is used to generate second information representing a second secret, such that the trustworthiness is determined without revealing the first secret and the second secret.

10. The method of claim 1, wherein the first set and/or the second set are/is rejected based on a correlation between the first information and the second information exceeding a correlation threshold value.

11. The method of claim 1 being performed in connection with a manufacturing process for manufacturing sets of the PUF, wherein a determined untrustworthiness of sets of the PUF leads to at least one of a pausing or modification of the manufacturing process.

12. A non-transitory computer-readable digital storage medium, having stored thereon, a computer program having a program code for performing, when running on a computer, a method according to claim 1.

13. A test system operable to:
test devices having an unclonable function (PUF); and
execute the method according to claim 1.

14. A device, comprising:
an unclonable function (PUF) having a plurality of PUF elements;
a circuitry operable to test the PUF elements with respect to a predefined property to determine information that indicates a result of the test, wherein the circuitry is operable to generate a signal indicating the information,
wherein the information comprises information indicating a respective subset of the set of PUF elements being used or unused when utilizing the respective set of the PUF elements, and/or the information comprises respective error correction information for a bit sequence generated when utilizing the respective set of the PUF; and
an interface operable to provide the signal.

15. The device of claim 14, wherein the circuitry is operable to determine a secret based on the PUF, and the device is operable to provide the signal without revealing the secret.
